(19) United States
(12) Patent Application Publication
(10) Pub. No.: US 2002/0060504 A1
(43) Pub. Date: May 23, 2002

(54) Multi-phase winding for an electric machine and process for its production

(76) Inventors: Joachim Sabinski, Dresden (DE); Hans Kuss, Dresden (DE)

Correspondence Address: COLLARD & ROE, P.C., 1077 Northern Boulevard, Roslyn, NY, 11576-1696, US

(21) Appl. No.: 09/974,993

(22) Filed: Oct. 11, 2001

Related U.S. Application Data
(63) Continuation-in-part of application No. 09/416,850, filed on Oct. 12, 1999, now abandoned.

(30) Foreign Application Priority Data
Oct. 12, 1998 (DE) 198 46 923.3

(51) Int. Cl. H02K 1/00; H02K 3/00

(52) U.S. Cl. 310/179

(57) ABSTRACT

A winding for multi-pole electrical machines. The device can be a synchronous machine with permanent magnet excitation. The invention is based on solving the problem for providing a winding for heavy duty electrical machines that permits a compact design such as in the overhang of a set of coils. The winding losses including the additional losses in the windings are minimized and the winding is capable of being highly stressed, mechanically, electrically and thermally. Therefore the multi-phase winding of the invention is inserted into the slots of a stator of an electrical machine to be provided with wound coils. This winding within a slot is looped continuously per group of coils to the greatest possible extent, using square or rectangularly shaped litzendraht wire connectors. In this case, the teeth are directly wound with this wire so that two coil sides of different coils are disposed in the slot next to each other or one on top of the other, or only one coil side is disposed in the slot if the second coil is omitted. The advantages of this winding include very little overhang of coils, series-production of compact windings with very high mechanical strength, comparatively low winding and additional losses, a minimum number of switching connections versus conventional windings, and an enhanced dissipation of heat from the region of the winding heads into the lamination.

### CROSS REFERENCE TO RELATED APPLICATIONS

This application is a Continuation in Part Application of U.S. patent application Ser. No. 09/416,850 filed on Oct. 12, 1999, incorporated herein by reference and which priority is claimed under 35 U.S.C. § 120.

### BACKGROUND OF THE INVENTION

1. Field of the Invention

The invention relates to a winding of an electric machine, in particular for multi-pole electric machines with frequencies of greater than 50 Hz. These machines can include a rotary field machine with permanent magnet excitation, wherein this winding is preferably for a compact solution for drives.

2. The Prior Art

A multitude of windings for rotating permanent-magnet excited electrical machines are known from the prior art DE-PS 34 42 033 which describes a winding wherein two winding strands not overlapping one another are arranged per each tooth of the stator. In this case, winding strands are substantially the same but independent of each other whereby one end of each winding is separated from an adjacent end of an adjacent winding by at least one tooth. This tooth thereby has a low resistive short-circuited winding.

German Design Patent No. G 9212 889.0 shows a winding arrangement for a multi-phase electrical machine which has a preset number of coils in two layers, such as an upper layer and a lower layer. Each layer by itself is inserted into the stator slots in accordance with a single-layer winding. In this arrangement, the lower layer coils located in the lower layer are connected to and offset versus the upper-layer coils located in the upper layer. Thus, a field distribution corresponding with a two-layer winding of any type of chording is effected in the air gap of the electrical machine. This invention requires a conventional circuit with a corresponding structure enlarging the overhang of the coils. Furthermore it is relatively costly to produce switching connections between the coils.

DE-OAS 41 26 019 describes a winding that is brushed throughout. However, such a winding shows coils formed in the shape of a pole winding being wound in each case around one tooth. The coils are disposed one on top of the other. The application of stranded conductors for electrical machines is disclosed in DE-OS 25 11 567. The stranded conductors are placed on the outside of a rotor body as a lap winding. The individual stranded conductors have the shape of a segment of a circular ring.

### SUMMARY OF THE INVENTION

The problem of the prior art is solved according to the invention by providing a polyphase winding of a known type which is inserted into the grooves of a stator of an electrical machine. The winding which is continually looped per group of coils, is wound for the first time within a groove in the form of an insulated or partially insulated stranded conductor with a square or rectangular cross-section. The continually looped or wound winding, which means that the winding is continually looped throughout without any wiring connection, is connected in parallel without the usual switch connection, and is drawn as the transition from the 1^{st} coil to the 2^{nd} coil on the visible side.

The wires of the winding are preferably insulated in this connection. Each individual tooth of the stator lamination is directly wound in so that two coil sides of the different coils are disposed in the groove next to each other, and an intermediate insulation is preferably inserted between these coil sides. The effect of the winding as defined by the invention corresponds with the known two-layer chord winding. The polyphase winding is manufactured so that one coil of a strand is directly and continually wound around a tooth. To further continue the group of coils, the winding is wound around one or more adjacent teeth in one or two directions without interruption.

The intermediate insulation can be preferably inserted in the already half-filled groove prior to the start of the winding process around the adjacent tooth.

The invention can also include a novel type of winding design of a three-phase current winding, whereby the strand winding consists of one or several coil groups and a group of coils consists of at least two coils. Each complete coil is in this connection, wound around one single tooth. For example, in one embodiment, only every second tooth may be completely wound with a coil.

This means that one tooth not wound is present between each two wound teeth and therefore remains free. A very special winding of the three phase current winding is produced wherein less than half the coil in the three phase current machine generates the electric field. The coil width of a coil accordingly corresponds with only one stator groove pitch.

Normally this type of winding would produce many harmonics. However, this winding is designed so that there are considerable sub-harmonics generated to super impose over the harmonics so that the sum of the damaging effects of the sub-harmonics and the harmonics is minimized.

In addition the present invention is designed for a high pole type machine wherein high pole means that there are a high number of poles. This definition is characterized in “Electrical Machines” by G. Mutller Berlin, 1992.

This type of winding provides many advantages. For example, because of this winding, it is possible to manufacture machines with a very small overhang of their coils. In addition, it is possible to create an efficient series production of multi-pole machines. It is also possible to create a compact design of a winding with a high mechanical strength which can withstand high mechanical stresses. This type of coil also results in comparatively low winding losses and allows the design to be made with a minimum number of switching connections as compared to conventional windings. Finally, this winding can also achieve an enhanced dissipation of heat from the region of the winding heads into the lamination.

In addition, an embodiment of the invention also leads to a chorded multi-phase single-layer winding.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a side view of a first embodiment of the multi-phase winding according to the invention; and

FIG. 2 shows a side view of a second embodiment of the multi-phase winding.

### DETAILED DESCRIPTION OF PREFERRED EMBODIMENTS

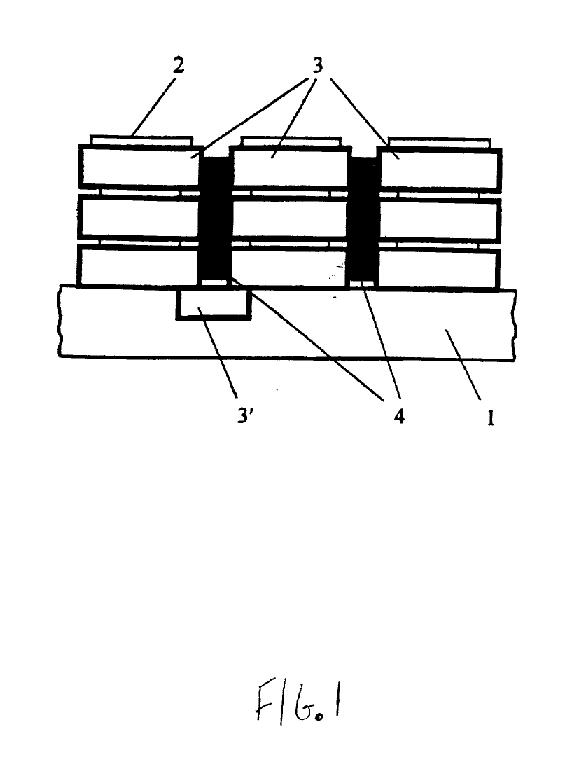

Referring in detail to the drawing, FIG. 1 shows an eight-pole three-phase winding in nine slots. The strand winding in this connection can consist of three coils 3 disposed next to one another. The strand is wound so that the center coil 3 is produced by directly winding the strand around a tooth 2, manually or by a machine.

The remaining two ends are continuously and directly wound in each case around the adjacent right and left tooth 2 so that a strand winding with three continuously wound coils 3 is produced.

A section of the stator lamination 1 is shown with teeth 2. One coil 3 of a group of coils is wound in this connection around each tooth, whereby the three coils are connected among each other continually, which means they are looped. The winding is continually looped, which means that the winding is wound throughout continually without any usual switch connection. In this case the coils of a group of coils wound on the individual teeth are continually looped among each other, whereas the coil groups, connected in parallel, are wired to each other.

The transition 3′ from the 1^{st} coil to the 2^{nd} coil is arranged on the invisible side of the stator lamination 1 and is now shown in the drawing. The intermediate layers 4 are arranged between the individual coils.

In a special embodiment, the winding can be continuously looped so that the two coil sides are disposed one on top of the other. The winding can be used for both rotating and linear electrical machines. Also another feature of this invention is that each coil is wound around only one tooth. In addition these wires can be twisted within a stranded conductor.

In another embodiment of the invention, as shown in FIG. 2 each coil 3 is wound around only every other tooth 2. This means that one tooth not wound is present between each two wound teeth and therefore remains free. A very special winding of the three phase current winding is produced wherein less than half the coil in the three phase current machine generates the electric field. The coil width of a coil accordingly corresponds with only one stator groove pitch.

Accordingly, while at least one embodiment of the present invention has been shown and described, it is to be understood that many changes and modifications may be made thereunto without departing from the spirit and scope of the invention as defined in the appended claims.

What is claimed is:

1. A polyphase winding of an electrical machine for electrical synchronous machines with frequencies greater than 50 Hz and having a series of teeth, and permanent magnet excitation, comprising:
a group of coils inserted into grooves of a stator of the electrical machine, said group of coils being continuously looped and comprising twisted, insulated wires having square cross sections and disposed within a set of stranded conductors;
wherein one coil of said group of coils is directly wound around each tooth, and wherein the sides of two different coils are disposed in one groove next to the other and separated by an intermediate insulation.

2. A polyphase winding of an electrical machine for high-pole electrical synchronous machines with frequencies greater than 50 Hz, and permanent magnet excitation, comprising:
a group of coils inserted into grooves of a stator of the electrical machine, said group of coils being continuously looped and comprising twisted, insulated wires having square cross sections and disposed within stranded conductors; wherein
one coil of said group of coils is directly wound around each tooth and wherein the sides of two different coils are disposed in one groove next to the other and separated by an intermediate insulation.

3. A polyphase winding of an electrical machine for electrical synchronous machines with frequencies greater than 50 Hz and having a series of teeth, and permanent magnet excitation, comprising:
a group of coils inserted into grooves of a stator of the electrical machine, said group of coils being continuously looped and comprising twisted, insulated wires having square cross sections and disposed within a set of stranded conductors;
wherein one coil of said group of coils is directly wound around every other tooth, and wherein the sides of two different coils are disposed in one groove next to the other and separated by an intermediate insulation.
